(19) United States
(12) Patent Application Publication
(10) Pub. No.: US 2009/0144520 A1
(43) Pub. Date: Jun. 4, 2009

(54) METHOD AND APPARATUS FOR SELECTING A DATA ITEM

(76) Inventors: Howard H. Taub, San Jose, CA (US); Helen Balinsky, Cardiff Wales (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/256,566

(22) Filed: Oct. 23, 2008

Related U.S. Application Data
(60) Provisional application No. 60/991,313, filed on Nov. 30, 2007.

(51) Int. Cl. G06F 12/02

(52) U.S. Cl. 711/220; 711/E12.014

(57) ABSTRACT

A method of selecting a data item from a memory within a first device, the method comprising the steps of evaluating within the first device a function of an input argument so as to form an output value, using the output value to select a data item from the memory and transmitting the selected data item to a second device.

This application claims the benefit of priority from provisional patent application Ser. No. 60/991,313, filed 30 Nov. 2007, entitled “Method and Apparatus for selecting a data item”, the contents of which are incorporated herein by reference.

### BACKGROUND OF THE INVENTION

For certain applications it may be desirable to select a data item from a group of data items in an unpredictable manner. When playing a game involving an element of chance, for example, it may be desirable to use a six-sided die to effectively select a number at random from the group of numbers 1 to 6. Another example is a game in which a player chooses a card from a “shuffled” deck of cards and the game state thereafter is determined by the information which is displayed on the selected card. Such systems and methods for the selection of a data item from a group of data items are, however, limited in the number and form of the data items and in the flexibility of the method of selection itself.

### SUMMARY OF THE INVENTION

According to a first aspect of the invention there is provided a method of selecting a data item from a memory within a first device, the method comprising the steps of evaluating within the first device a function of an input argument so as to form an output value, using the output value to select a data item from the memory and transmitting the selected data item to a second device.

According to a second aspect of the invention there is provided a method of selecting a data item from a memory tag, the memory tag including a pseudo-random number generator, the method comprising, in response to a communication signal from a memory tag reader, causing the pseudo-random number generator to generate a random number, using the random number to select a data item from the memory tag and transmitting the selected data item to an input device.

According to a third aspect of the invention there is provided an apparatus for selecting a data item comprising a first device comprising a data processor and a memory and a second device in communication with the first device, wherein the data processor is arranged to evaluate a function of an input argument so as to form an output value, to use the output value to identify a data item in the memory, to retrieve the data item and to transmit it to the second device for out put.

### BRIEF DESCRIPTION OF THE FIGURES

Embodiments of the present invention will now be described, by way of non-limiting example only, with reference to the accompanying figures, in which:

FIG. 1 schematically illustrates a system for selecting a data item constituting a first embodiment of the present invention;

FIG. 2 schematically illustrates a second embodiment of a system for selecting a data item;

FIG. 3 schematically illustrates a memory tag and a tag reader interface circuit suitable for use in the embodiments shown in FIGS. 1 and 2;

FIG. 4 schematically illustrates a method constituting an embodiment of the present invention of selecting a data item from a group of data items stored in a memory tag;

FIG. 5 schematically illustrates a second method of selecting a data item from a group of data items stored in a memory tag constituting an embodiment of the present invention; and

FIG. 6 schematically illustrates a third method of selecting a data item from a group of data items stored in a memory tag constituting a further embodiment of the present invention.

### DESCRIPTION OF PREFERRED EMBODIMENTS OF THE INVENTION

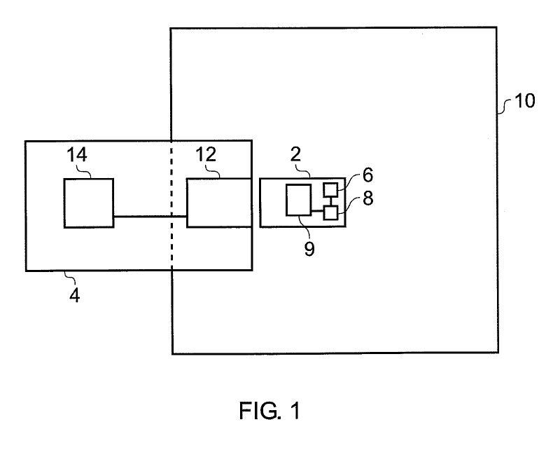

A system constituting an embodiment of the present invention for selecting a data item is shown in FIG. 1 and comprises first device, such as a memory tag 2 and a second device, such as a tag reader 4. The memory tag 2 and the tag reader 4 are capable of communicating with one another, for example, by wireless communication as is known to the person skilled in the art. The memory tag 2 comprises a tag memory 6 and a data processor 8. The data processor 8 is in communication with the memory 6. The memory tag also includes a communications interface 9 which allows the tag to be energised by the tag reader and to be interrogated by the reader. The memory tag 2 is attached to an object 10 and data associated with the object 10 may, for example, be stored in the tag memory 6. Alternatively, the tag memory 6 may contain data associated with a further object (not shown) which is associated with the object 10.

The tag reader 4 comprises a tag reader interface circuit 12 and an output device 14 which is capable of outputting a message. The message may, for example, comprise text, image or video content or any combination thereof and the output device 14 may comprise a display. Alternatively or additionally the message may comprise audio content and the output device 14 may comprise a loud-speaker. In one implementation the tag reader 4 may be a portable hand-held device such as a cell phone or a personal digital assistant (PDA), or some other mobile or ultra mobile computing device.

The tag reader emits an RF field from the tag reader interface circuit which, when in sufficiently close proximity to the tag 2, energises the tag so that it can select a data item to be transmitted to the tag reader, as will be described in greater detail later. Modulation schemes for RF-ID tags and memory spot devices are known to the person skilled in the art and need not be described in detail here.

The tag reader includes an energy store (not shown) to power the tag and may further include a switch and/or motion detector to cause the tag reader interface 12 to be energised to read the tag 2.

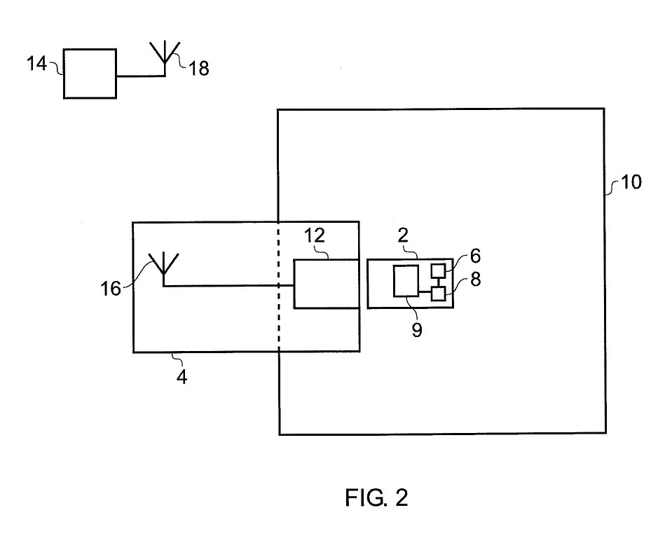

FIG. 2 shows a second embodiment of a system for selecting a data item. In this embodiment the output device 14 is remote from the tag reader 4. The tag reader 4 incorporates an antenna 16 and the output device 14 is connected to an antenna 18. In use, the output device 14 communicates with the tag reader 4 via the antennas 16 and 18.

In use, the data processor 8 of the memory tag 2 of the embodiment of FIG. 1 or 2 selects a data item from the tag memory 6 and provides it to the tag reader 4 via the communications interface 9. The memory tag 2 may, for example, provide a data item to the tag reader 4 in response to an initiation signal being received by the memory tag 2 from the tag reader 4 when the tag reader 4 is brought into sufficient proximity with the memory tag 2 or merely by being irradiated by an interrogation signal. The data items stored in the tag memory 6 are accessed in an unpredictable sequence. The data item is subsequently converted into a message, or a form intelligible to the user, by the output device 14. The message thus generated may be received by a user. The tag reader 4 and/or the output device 14 may be shared between users. Alternatively, each user may have their own tag reader 4 and their own output device 14.

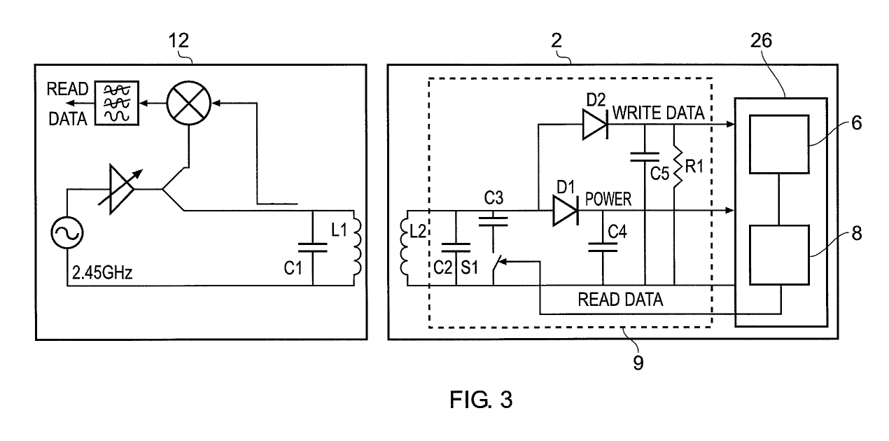

An exemplary implementation of a memory tag 2 and tag reader interface circuit 12 is schematically illustrated in FIG. 3 in which conventional component identifications (C-capacitor, L-inductance, R-resistor, D-diode and S-switch) are used. The memory tag 2 includes a memory tag interface circuit 9 and a circuit module 26. The circuit module 26 comprises the tag memory 6 and the data processor 8. The memory tag interface circuit 9 and the circuit module 26 are connected to one another via a data bus to allow transfer of data to and from the processor 8. The, memory tag interface circuit 9 comprises an RF transponder circuit including a capacitor C2 which, in combination with an antenna coil L2, forms a resonant circuit with component values being chosen to tune the combination to a frequency which is substantially matched to that generated by the tag reader interface circuit 12 for inductive coupling therewith. As shown in FIG. 3, the resonant frequency may, for example, be approximately 2.45 GHz. The portion of the memory tag interface circuit 9 responsible for power supply is diode D1 and capacitor C4, with diode D1 rectifying the alternating current generated by the inductive coupling and the capacitor C4 acting as a power supply store. The portion of the memory tag interface circuit 9 responsible for the reception of data from the tag reader interface circuit 12 is diode D2, capacitor C5 and resistor R1, which together form a, simple envelope detector. Data thus received by the memory tag 2 is stored in the tag memory 6 after being processed or interpreted by the data processor 8. The portion of the memory tag interface circuit 9 responsible for sending data back from the tag memory 6 is formed by the tuned circuit L2/C2 in combination with S1 and C3. Switching C3 in and out of the circuit using S1 changes the resonance of the tuned circuit L2/C2 resulting in phase modulation of the reflected power directed from the memory tag 2 to the tag reader interface circuit 12.

The purpose of embodiments of the present invention is, for any sequence of interrogations of the same memory tag by one or more readers, to produce a pseudo-random sequence of output data irrespective of which readers are used, how many readers are used, or in which order the readers are used to interrogate the memory tag. Suppose a group of N data items data(1), data(2), . . . , data(N) are stored in the tag memory 6. For any sequential interrogations of this tag, one randomly or pseudo-randomly selected item from this group data(i) is selected, communicated to the currently interrogating reader and the contents of data(i) is delivered to the user by means of the correspondent applications.

In one of the embodiment of the current invention the memory tag includes a random or pseudo-random number generator (PRNG) in combination with sufficient memory to store all the required data items. Then, when the chip is interrogated, the PRNG generator produces a pseudo-random number and the contents of a corresponding data item data(i) is communicated to the interrogating reader from the memory tag.

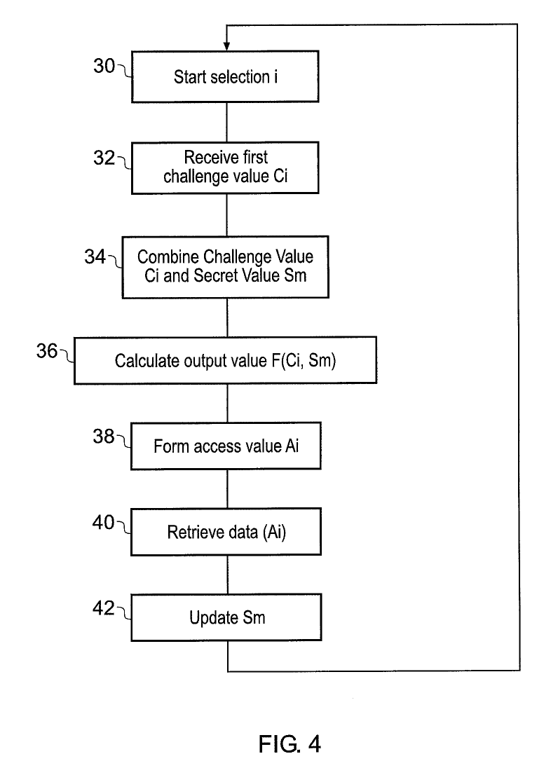

FIG. 4 illustrates the steps of a further embodiment of the present invention for pseudo-randomly selecting a data item to be retrieved from the memory tag 2. The steps can be implemented by a programmable data processor or by suitably configured hardware. The method can be used, for example, to replicate the drawing of a card from a stack of cards. Once a card has been drawn it can be returned to the stack of cards, that is replaced, or be permanently removed from further selection. The former option can be regarded as “selection with replacement” whilst the latter is “selection without replacement”.

The selection operation i is initiated by transmission of an initiation signal from the tag reader 4 to the memory tag 2. The tag memory 6 stores M secrets S₁, S₂, . . . , S_{M} where M is an integer. The secrets Sₘ are numbers and M can be any positive integer value. Each memory tag should have at least one secret (whose contents cannot be read, but can be reset). The secrets are only accessible by the data processor 8 and the values of the secrets cannot, in particular, be accessed for reading by the tag reader 4 in normal use.

The selection operation commences at step 30. The data processor 8 receives (step 32) a first challenge value Cᵢ generated by the tag reader, where Cᵢ can be any number, even the same number for any consecutive challenges and combines the challenge value Cᵢ with the currently stored secret Sₘ (step 34), where the combining operation can be performed as concatenation, interleaving or any other similar operation. The secret Sₘ is combined with the challenge value Cᵢ to form an input argument for a function F. The secret Sₘ and the challenge value Cᵢ may, for example, be expressed in a binary format and the bits of the secret Sₘ and the challenge value Cᵢ may be interleaved. Alternatively, the secret Sₘ and the challenge value Cᵢ may be concatenated or added. The function F is preferably a one-way function. The one-way function F possesses the property that it is not computationally feasible to calculate an input argument from knowledge of an output argument. The one-way function F may, for example, be a hash function such as the SHA-1 hash function, which is a U.S. Federal Information Processing Standard that is widely used in security applications and protocols. The one-way function F generates an output argument Hᵢ at step 36 which is then operated on at step 38 to convert the number Hᵢ into an access value Aᵢ such that 1≦Aᵢ≦N. The access value Aᵢ may, for example, be calculated using the modulo function, i.e. Aᵢ=Rᵢ mod N. Alternatively, the access value Aᵢ may be calculated by selecting a subset of the digits or, if expressed as a binary number, the bits of the number Hᵢ. However, if any alternative to the formula Aᵢ=Rᵢ mod N is used to compute the access number Aᵢ, it should be guaranteed that each content data item data(i) has an equal probability of being selected. The access value Aᵢ is then used as an index in the data array data(1), data(2), . . . , data(N) to select the data item data(i) at step 40 i.e. data(i)=data(Aᵢ).

The “one-way” property of the one-way function F coupled with the fact that the values of the secrets S₁, S₂, . . . , S_{M} are unknown to the tag reader 4, means that it is not possible to predict which data item will be selected at selection operation i from knowledge of the challenge numbers Cᵢ. Ideally, the one-way function F should also possess the property that a small change in the input argument (e.g. 1 bit) should cause a large change in the output value (e.g. half of the bits). This, so-called “avalanche effect” may be exploited to ensure that the output value Hᵢ is a pseudo-random number (PRN). This is accomplished at selection operation i by updating the value of the secret Sᵢ at step 42 after selecting the data item data(i). For example, the secret Sₘ may be set equal to the output argument Hᵢ or may be at least partially over-written by the output argument Hᵢ. Alternatively, the value of the secret Sₘ may be updated in some other way. Sₘ may, for example, be simply incremented or decremented by any prefixed number, so that Sₘ=Sₘ+1 or Sₘ=Sₘ−1. Furthermore, at each selection operation i, a different secret Sₘ, 0≦m≦M may be selected. The challenge value Cᵢ may also change between selections. Thus, at least Cᵢ changes or both the numbers Sᵢ and Cᵢ changes at each selection operation i and the input argument to the one-way function F changes at each selection operation i. As a result of the avalanche effect associated with the one-way function F, the one-way function F generates a PRN at its output.

It should be understood that if a pseudo-random number generator (PRNG) were incorporated into the tag reader 4 and used to generate a PRN which was provided as the sole input to the one-way function 30, then such a system would be vulnerable to exploit by some players. If there is a dependence on the input from the reader, this can create a loophole allowing some game players to control to a certain degree which content item they receive (or not receive) in their turn. In such instances special care should be taken to ensure that tag reader is not capable of holding a local copy of any one of the content data items from memory tag. Furthermore, using a PRNG incorporated into the tag reader to read the corresponding data portion from memory tag with multiple readers makes it difficult to estimate properties of the combined random sequence. For example, the PRNG on the tag readers may be accidentally or intentionally synchronized or reset etc.

When the object 10 is associated with a game, the method of FIG. 4 of selecting a data item with replacement allows the system for selecting a data item, such as the system of FIG. 1 or 2, to function as an electronic die. Such an electronic die would be more versatile than a conventional die. In traditional dice it is hard to make a fair dice with each side having an equal probability of being selected. The amount of sides in commercially available dices is limited to relatively small numbers. Memory tag based dice can have any number of “sides” without compromising dice fairness, since every content data item has the same chance of being selected on every draw. In the case of games without replacements, memory tag based dice can ensure that any “side” can be selected only once at any round without compromising fairness for each “side”.

The electronic die could, for example, select a PRN from a predetermined group of numbers in which the group size may be chosen arbitrarily and the numbers themselves may also be chosen arbitrarily. Alternatively, a system for selecting a data item such as the system of FIG. 1 or 2 may act as an electronic deck of cards. Such an electronic deck of cards would also be more versatile than a conventional deck of cards since the message corresponding to the data item selected is not limited to the type of graphic contents which may be presented on a conventional card, but may be delivered to a player by the output device 12 as text, image, video or audio content or any combination thereof.

In the method of selection with replacement of FIG. 4, all of the data items data(1), data(2), . . . , data(N) which were available for selection at selection operation i are still available for selection at the next selection operation i+1. Thus, the method illustrated in FIG. 4 is analogous to the example of a shuffled deck of cards in which a card is selected from the deck of cards, the contents of the selected card are displayed, the selected card is replaced, and the deck is re-shuffled in preparation for the next selection.

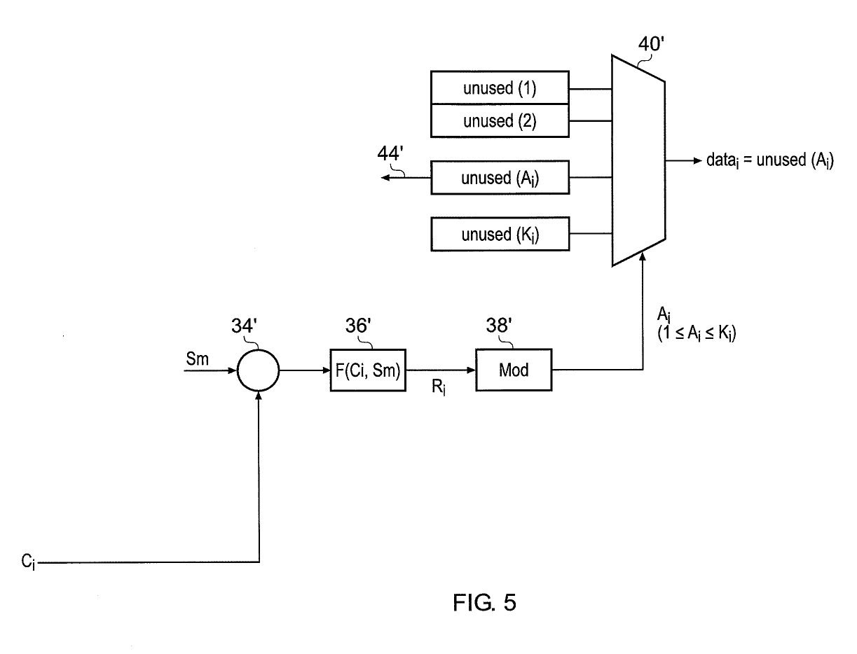

In contrast, the selection process shown in FIG. 5 corresponds to the case where a data item is selected from a group of data items without replacement. This process is analogous to the example of a shuffled deck of cards where a card is selected from the deck, the contents of the selected card are displayed and the card is not replaced before the next selection. Depending on the rules of a game this selected (played) card may be removed until the next round or until the end of the game. FIG. 4 has been drawn in terms of a flow diagram for a programmable data processor. The process of FIG. 5 can also be implemented in a program, but to show the flexibility of the implementing technology, FIG. 5 will be described in terms of dedicated hardware implementation. Hardware components performing equivalent operations to the method steps in FIG. 4 are designated with like reference numerals with an added apostrophe. The selection process of FIG. 5 is performed by the data processor 8 in the memory tag 2. FIG. 5 illustrates this method for a selection process i in which a data item data(i) is selected from a group of Kᵢ unused data items unused(1), unused(2), . . . , unused(Kᵢ) stored in the tag memory 6. As in the previous embodiment of FIG. 4, the secret Sᵢ is combined together with the challenge number Cᵢ to form the input argument to the “one-way” function F. An access value Aᵢ is calculated by a modulo calculator 38′ such that 0≦Aᵢ≦Kᵢ−1. The access value Aᵢ may, for example, be calculated using the modulo function i.e. Aᵢ=Hᵢ mod Kᵢ. The data item unused(Aᵢ) selected by a memory addressing circuit 40′ is subsequently removed from the unused data item array as indicated by the arrow designated 44. The list of unused (available for selection) items is maintained in an electronic file in the memory of the memory tag. When the item is selected, the correspondent entry is removed or marked as no longer available. Correspondingly, the base Kᵢ₊₁ used by the operation 38′ for the next selection operation i+1 is also decremented i.e. Kᵢ₊₁=Kᵢ−1. If the corresponding entry was removed, then

Hᵢ₊₁ mod(Kᵢ−1)

where Kᵢ is counted by unmarked places if used entries are marked or as sequential number if used entries are removed.

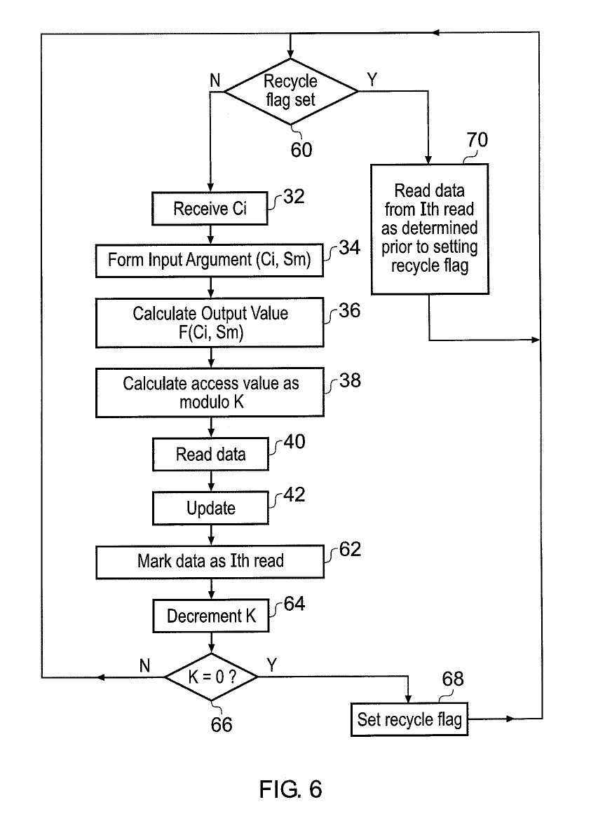

FIG. 6 shows a further embodiment of a method of selecting a data item which is analogous to the example of a shuffled deck of cards where a card is selected from the deck, the contents of the selected card are displayed, the card is placed on the bottom of the deck and the order of the cards in the deck is preserved thereafter i.e. the deck is not shuffled after the card is replaced. The embodiment of FIG. 6 is similar to FIG. 4 except that steps must be added to note when an item has been selected, as in FIG. 5, to record the order in which items were selected and to modify the list of unselected items so as to restrict the choice.

Because it is necessary to know whether the selection is to be regarded as being the first pass through the data, e.g. the first pass through a set of cards, or a subsequent pass in which the order of the first pass is to be preserved, a “recycle flag” is provided. The recycle flag indicates that either the data order is to be determined by the pseudo-random number generator when the flag is not set, or that a previously determined sequence is to be reused when the recycle flag is set. Thus a test for the condition of the recycle flag is provided at step 60. If the flag is not set then control is passed to steps 32 to 42 described hereinbefore.

Following step 42 a sequence identifier is added to the data as it is read at step 62 and the data is no longer selectable for reading. The value of K used in the modulo calculation to access the unread data is decremented such that it always corresponds to the number of unread data items. The access value is used to read an item indicated by the access value from a list composed of the K unread data items.

From step 64 control is passed to step 66 where a test is made to see if K=0, if not control is returned to step 60.

If K=0, then control is passed to step 68 where the recycle flag is set, thereby indicating that the data items are to be re-read in the read sequence that has been established prior to K decrementing to 0. From step 68 control is returned to step 60.

If step 60 determines that the recycle flag is set then control is passed to step 70 where the next data item in the already determined sequence is re-read.

Thus, an apparatus and method for the selection of a message from a database of messages or other data stored in a memory tag is provided in which the method for the selection of the message provides random or pseudo-random message outputs and the contents of the message may be associated with an object to which the memory tag is attached.

1. A method of selecting a data item from a memory within a first device, the method comprising the steps of:
evaluating within the first device a function of an input argument so as to form an output value;
using the output value to select a data item from the memory; and
transmitting the selected data item to a second device.

2. A method as claimed in claim 1, in which the function comprises a one-way function.

3. A method as claimed in claim 2, in which the function further comprises a second function arranged to map an output of the one-way function to memory addresses within the memory.

4. A method as claimed in claim 1, in which the input argument is derived, at least in part, from data provided by the second device.

5. A method as claimed in claim 1, in which the input argument is kept secret from the second device.

6. A method as claimed in claim 1, in which a signal from the second device comprises a challenge value and the input argument is calculated according to the steps of:
selecting a secret number from a group of secret numbers stored in the first device; and,
combining the selected secret number and the challenge value,
in which the value of the selected secret number is held secret with respect to the second device.

7. A method of selecting a data item as claimed in claim 6, comprising the further step of updating the value of the selected secret number stored in the first device.

8. A method of selecting a data item as claimed in claim 7, in which updating the value of the selected secret number stored in the first device comprises incrementing or decrementing the value of the selected secret number stored in the first device or at least partially over-writing the value of the selected secret number with the output value.

9. A method of selecting a data item as claimed in claim 1, further comprising the steps of:
converting the selected data item into a message comprising text audio, image or video content or any combination thereof; and,
outputting the message.

10. A method of selecting a data item as claimed in claim 1, in which the function is a hash function.

11. A method of selecting a data item from a memory tag, the memory tag including a pseudo-random number generator, the method comprising:
in response to a communication signal from a memory tag reader, causing the pseudo-random number generator to generate a random number;
using the random number to select a data item from the memory tag; and
transmitting the selected data item to an input device.

12. An apparatus for selecting a data item comprising:
a first device comprising a data processor and a memory; and
a second device in communication with the first device; and
wherein the data processor is arranged to evaluate a function of an input argument so as to form an output value, to use the output value to identify a data item in the memory, to retrieve the data item and to transmit it to the second device for output.

13. An apparatus as claimed in claim 12, in which the first device is a memory tag and the second device is a memory tag reader.

14. An apparatus as claimed in claim 12, in which the function comprises a one-way function.

15. An apparatus as claimed in claim 14, in which the function further comprises a mapping function to map to output of the one-way function onto memory addresses of the memory.

16. An apparatus as claimed in claim 13, in which the memory tag is powered by irradiation from the tag reader.

17. An apparatus for selecting a data item as claimed in claim 13, in which the signal from the tag reader comprises a challenge value and the data processor is arranged to:
use the challenge value as an index to select a secret number from a group of secret numbers stored in the memory tag; and
form the input argument by combining the selected secret number and the second challenge value, wherein the value of the secret number is held secret by the memory tag with respect to the tag reader.

18. An apparatus for selecting a data item as claimed in claim 17, in which the data processor is arranged to update the value of the selected secret number stored in the memory tag by incrementing or decrementing the value of the selected secret number stored in the memory tag, or by at least partially over-writing the value of the selected secret number with the value of the output argument.

19. An apparatus for selecting a data item as claimed in claim 13, further comprising an output device which converts the selected data item into a message comprising text, audio, image or video content or any combination thereof and outputs the message.

20. A system for selecting a data item as claimed in claim 19, in which the tag reader is incorporated into a cell phone or a personal digital assistant (PDA).
